(19) United States
(12) Patent Application Publication
(10) Pub. No.: US 2015/0286271 A1
(43) Pub. Date: Oct. 8, 2015

(54) SYSTEM AND METHOD FOR PREDICTING A CENTRAL PROCESSING UNIT IDLE PATTERN FOR POWER SAVING IN A MODEM SYSTEM ON CHIP

(71) Applicant: Samsung Electronics Co., Ltd., Gyeonggi-do (KR)

(72) Inventors: Tushar VRIND, Gyeonggi-do (KR); Balaji SOMU KANDASWAMY, Bangalore (IN); Raju Siddappa UDAVA, Bangalore (IN); Venkata Raju INDUKURI, Bangalore (IN)

(73) Assignee: Samsung Electronics Co., Ltd.

(21) Appl. No.: 14/678,164

(22) Filed: Apr. 3, 2015

Related U.S. Application Data
(60) Provisional application No. 61/974,748, filed on Apr. 3, 2014.

(30) Foreign Application Priority Data
Feb. 11, 2015 (KR) 10-2015-0021124
Mar. 19, 2015 (KR) 10-2015-0038425

(51) Int. Cl. G06F 1/32

(52) U.S. Cl. CPC G06F 1/3278; G06F 1/329; G06F 1/3243; G06F 1/3287

(57) ABSTRACT

A method and system for providing power management in a system employing a Central Processing Unit (CPU) and an operating system are provided. The method includes monitoring idle times of the CPU; predicting an idle pattern based on the monitored idle times; and determining a selective sleep of a peripheral device based on the predicted CPU idle pattern.

### PRIORITY

This application claims priority under 35 U.S.C. §119(e) to a U.S. Provisional Application filed on Apr. 3, 2014 and assigned Ser. No. 61/974,748, and under 35 U.S.C. 119(a) to a Korean Patent Application filed in the Korean Intellectual Property Office on Feb. 11, 2015 and assigned serial No. 10-2015-0021124 and to a Korean Patent Application filed in the Korean Intellectual Property Office on Mar. 19, 2015 and assigned serial No. 10-2015-0038425, the entire contents of each of which are incorporated herein by reference.

### BACKGROUND

1. Field of the Disclosure

The embodiments herein relate generally to power saving in a modem System on Chip (SoC), and more particularly, to a system and method for machine learning to predict Central Processing Unit (CPU) idle pattern for power saving in a modem SoC.

2. Description of the Related Art

An SoC is an Integrated Circuit (IC), typically used in embedded devices, that integrates all components of a computer or other electronic system into a single chip. In electronic and embedded devices, reducing power consumption can be a difficult task, as a microcontroller/microprocessor of the embedded device must stay alert in order to execute processes and provide output to a user as soon as possible. Various improvements are being developed in order to reduce power consumption in embedded devices without affecting the performance of the devices.

### SUMMARY

The present disclosure has been made to address the above-mentioned problems and disadvantages, and to provide at least the advantages described below.

An aspect of the present disclosure provides a method of providing power management in a system employing a Central Processing Unit (CPU) and an operating system. The method includes monitoring idle times of the CPU; predicting an idle pattern based on the monitored idle times; and determining a selective sleep of a peripheral device based on the predicted CPU idle pattern.

Another aspect of the present disclosure provides an apparatus for performing power management in a system employing a Central Processing Unit (CPU) and an operating system. The apparatus includes the CPU, and a monitoring unit adapted for monitoring idle times of the CPU; a predictor adapted for predicting a idle pattern of the CPU based on the monitored idle times; and a controller adapted for determining a selective sleep of a peripheral device based on the predicted CPU idle pattern.

### BRIEF DESCRIPTION OF THE DRAWINGS

The above and other objects, features, and advantages of the present disclosure will be more apparent from the following description, taken in conjunction with the accompanying drawings, in which:

FIG. 1 is a schematic diagram illustrating CPU idle implementation during sleep mode in an SoC of an existing system;

FIG. 2 is a schematic diagram illustrating a “selective sleep of peripherals and sub systems” mode in an SoC, according to an existing system;

FIG. 3 is a timing graph illustrating variation of an existing CPU idle period varying due to hardware transient response behavior;

FIG. 4 is a timing graph illustrating variation of an existing CPU idle period varying due to PDCCH reception;

FIG. 5 is a timing graph illustrating existing distributed CPU idle time due to short DRX in long DRX cycles;

FIG. 6 is a schematic diagram illustrating a model of a machine learning process to predict a CPU idle time, according to an embodiment of the present disclosure;

FIG. 7 is a schematic diagram illustrating a method of making decisions over time based on behavior prediction, according to an embodiment of the present disclosure; and

FIG. 8 is a schematic diagram illustrating an event fingerprint method for making decisions over time based on behavior prediction, according to an embodiment of the present disclosure.

### DETAILED DESCRIPTION

Hereinafter, embodiments of the present disclosure are described in detail with reference to the accompanying drawings. However, the present disclosure is not limited to the described embodiments. In the following description, the same or similar reference numerals are used to indicate the same or similar components in the accompanying drawings. Detailed descriptions of known functions and configurations may be omitted in order to avoid obscuring the subject matter of the present disclosure.

In an embedded microprocessor/microcontroller-based device, one way of reducing power consumption is to turn off external components in the system and gate clocks to peripheral units based on system operations. These power-saving procedures can be triggered and implemented when a CPU of the device is in an idle state.

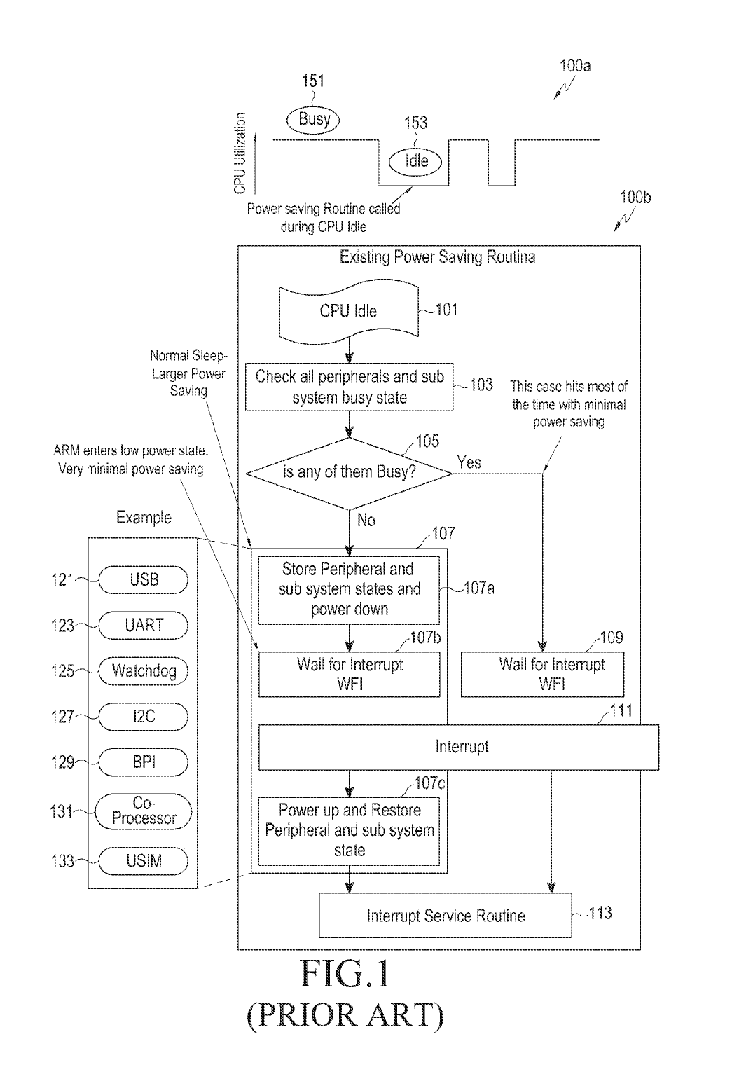

FIG. 1 is a schematic diagram illustrating CPU idle state implementation during sleep mode in an SoC of an existing system.

Referring to a method 100b of FIG. 1, sleep mode is used to trigger a CPU idle state while conditions are satisfied. The example of FIG. 1 is based on interaction between peripheral units and the CPU of the device, or procedures performed within the peripherals that are induced due to CPU actions, such as Direct Memory Access (DMA) or device driver invocations. When the CPU enters an idle state in step 101, all peripheral units and sub systems are checked to determine whether each of these units and sub systems is in a busy state, in step 103. Such peripheral units and sub systems can include, but are not limited to, Universal Serial Bus (USB) 121, Universal Asynchronous Receiver/Transmitter (UART) 123, watchdog 125, Inter-Integrated Circuit (I2C) 127, Serial Peripheral Interface (SPI) 129, co-processor 131, Universal Subscriber Identifier Module (USIM) 133, etc. If the CPU determines that any of the peripheral units or sub systems is busy, in step 109, then the CPU will enter into a Wait For Interrupt (WFI) state, in step 109. Once the CPU enters the WFI state, the CPU will be in idle state and no process will be under execution. If the CPU receives any process for execution in step 111, an interrupt service routine begins in step 113.

If the CPU determines that none of the peripheral units and sub systems is busy in step 105, then, in step 107, the CPU stores current states of the peripheral units and sub systems and powers the peripheral units and sub systems down, in step 107a. Once the peripheral units and sub systems are powered-down, the CPU enters the WFI state in step 107b, in which the CPU will be in an idle state and no process will be under execution. If the CPU receives any process for execution in step 111, an interrupt signal will be received and the CPU will be powered up and the states of all of the peripheral units and sub systems will be restored for execution, in step 107c. Upon restoration and powering up of the peripheral units and subsystems, the CPU initiates an interrupt service routine to handle process execution, in step 113. A schematic graph 100a of FIG. 1 illustrates CPU utilization in a busy state 151 and an idle state 153 according to the above-described power saving routine.

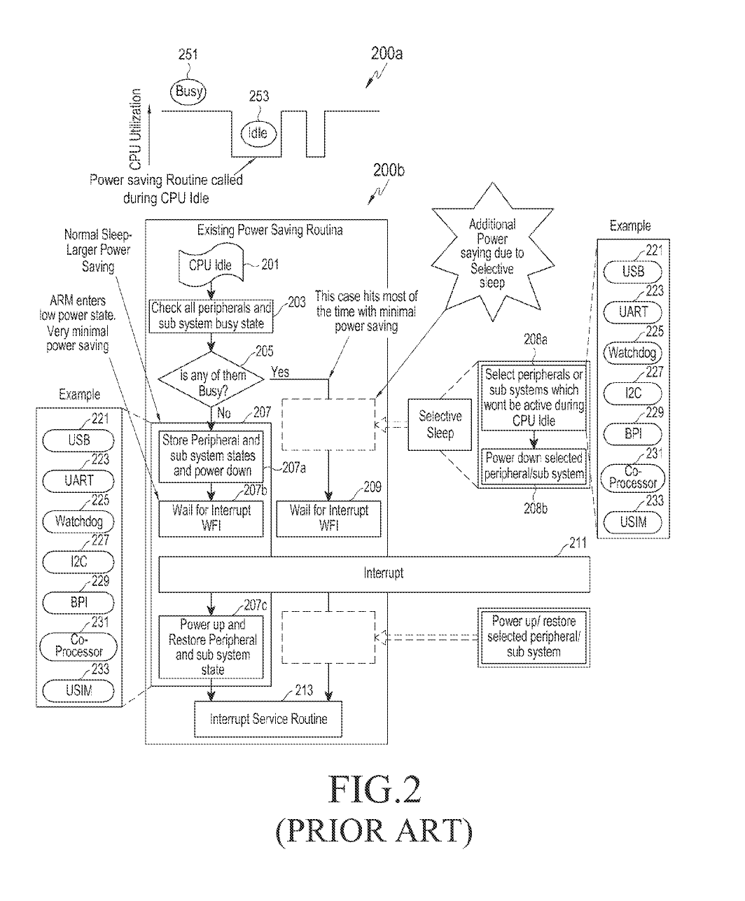

FIG. 2 includes a schematic diagram 200a illustrating a “selective sleep of peripherals and sub systems” mode in an SoC of an existing system and a flowchart 200b of a corresponding method. The steps of the method 200b of FIG. 2 are similar to that of corresponding steps of the method 100b of FIG. 1, except for the addition of steps 208, 208a, 208b, and 211, as described in detail hereinbelow. A further description of steps of method 200b corresponding to similar steps of method 100b of FIG. 1 is omitted for clarity and conciseness. The “selective sleep of peripherals and sub systems” mode is triggered, in step 208, during a CPU idle state in which a list of certain conditions is satisfied. Selective sleep of peripherals and sub systems mode is similar to the sleep mode as described in FIG. 1, but, instead of sending all peripherals and sub systems into sleep mode during an idle period of the CPU, the CPU detects and selects only the peripherals and sub systems that won't be active during and CPU idle period in step 208a, and the CPU controls that only the selected peripherals and sub systems transit into sleep mode in step 208b. When an interrupt occurs at step 211 after entering the selective sleep mode in step 208 and entering the WFI state in step 209, power-up/restoration of the selected peripherals and subsystems is performed in step 212. After the power-up/restoration is performed in step 212, the interrupt service routine is performed in step 213.

The sleep mode as described with reference to FIG. 1 and the selective sleep mode as described with reference to FIG. 2 share the same drawbacks. When the CPU idle state is not maintained for a long period of time (i.e., a short CPU idle time), turning off external components or gating clocks to peripherals and restoring them immediately within a short period of time may end up in consuming more power instead of saving power. This increase is caused by an additional current surge during the OFF to ON transition state of the CPU, before the CPU stabilizes, and thereby consuming more power than usual. Even though power consumed by peripherals and sub systems in a selective sleep mode is less than consumption in a regular sleep mode, the power consumption of the selective sleep mode is still a point of concern, and there is a need to improve the performance of such systems.

A CPU idle period in a system can have a pattern designated for a particular scenario. For example, for a given scenario, a CPU idle period can follow a particular pattern regularly after execution of a particular interrupt or a task. The length of a CPU idle period can vary each time the CPU idle pattern occurs, but the CPU idle period can be predicted to a certain extent. However, statically predicting CPU idle period based on a protocol, design, or architecture may not be feasible. A CPU idle period must be predicted during run-time, as the CPU idle period can vary based on the actual implementation. For example, consider the 3^{rd} Generation Partnership Project (3GPP) specified Long-Term Evolution (LTE) Discontinuous Reception (DRX) which is a process of turning-off a Radio Frequency (RF) receiver when the modem is not expected to receive any data for a pre-determined period. The DRX cycle is configured to allow modem to enter a sleep state and wake up periodically to read control channel information of a Physical Downlink Control CHannel (PDCCH).

Even though the DRX cycle is periodic, as per the 3GPP specification, the CPU ON time, and thus idle time, may vary due following conditions:

A: Due to hardware transient response and processing offload:

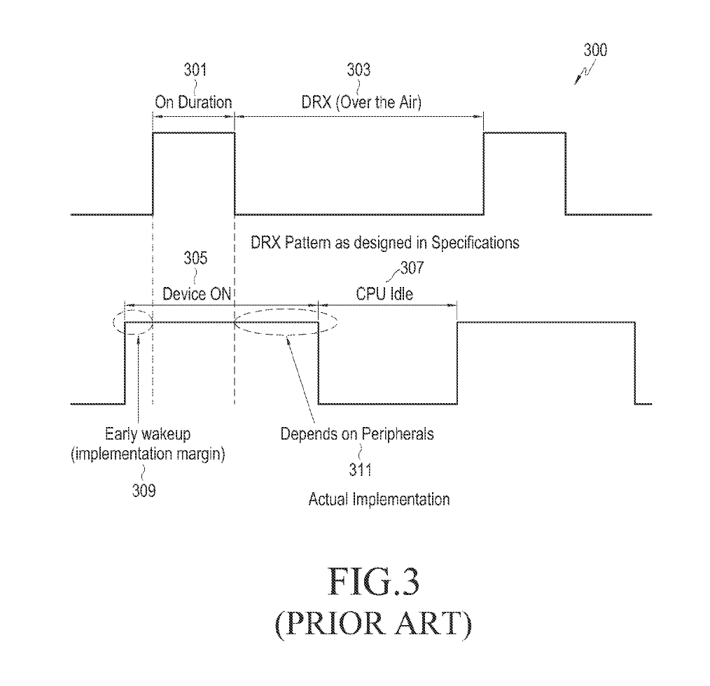

FIG. 3 is a timing graph illustrating variation of an existing CPU idle period due to hardware transient response behavior.

Referring to FIG. 3, a graph 300 shows a DRX cycle pattern according to the 3GPP specification, which shows durations 301 and 303 during which the device will be in an ON state and a DRX state, respectively. During the DRX state, the device will be performing over-the-air communication and CPU will be in an idle state. But in an actual implementation, the durations 305 and 307 for the device ON state and CPU idle state, respectively, vary, because, during the device ON state, the system requires some time to wake up and restore the peripherals considering the stabilization of hardware, and before entering CPU idle period, the system requires some time to turn off the peripherals. The additional time taken to wake up and restore the peripherals is called as “early wake up” time 309. In FIG. 3, the additional time consumed by the system to wake up the peripherals 309 and to turn off the peripherals 311 is marked with dotted circles on both sides of the device ON period 305. The additional time consumed by the system during waking up period 309 and CPU idle period 309 can vary.

B: During PDCCH reception:

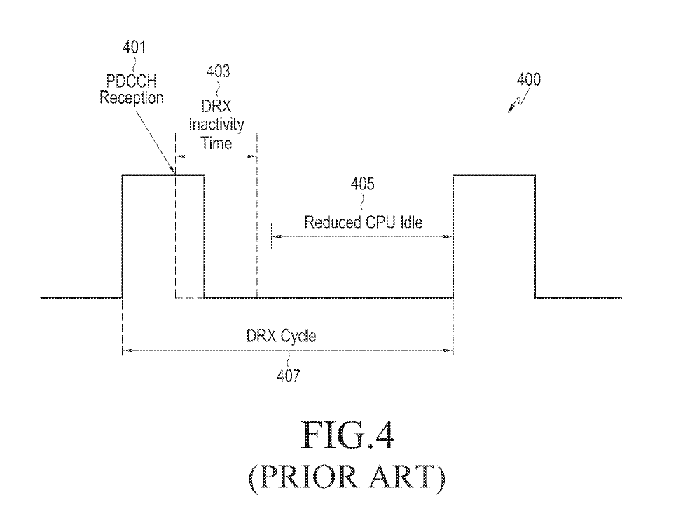

FIG. 4 is a timing graph 400 illustrating variation of an existing CPU idle period varying due to PDCCH reception.

Referring to FIG. 4, as shown in graph 400, during a CPU ON state, a downlink assignment is received via a PDCCH at time 401. The downlink assignment sets a New Data Indicator (NDI) to look for incoming data, and therefore, a DRX inactivity timer is triggered for period 403. The NDI consumes some of a CPU idle duration, thereby reducing the CPU idle duration 405 for a DRX cycle 407.

C: Short DRX Cycles are configured:

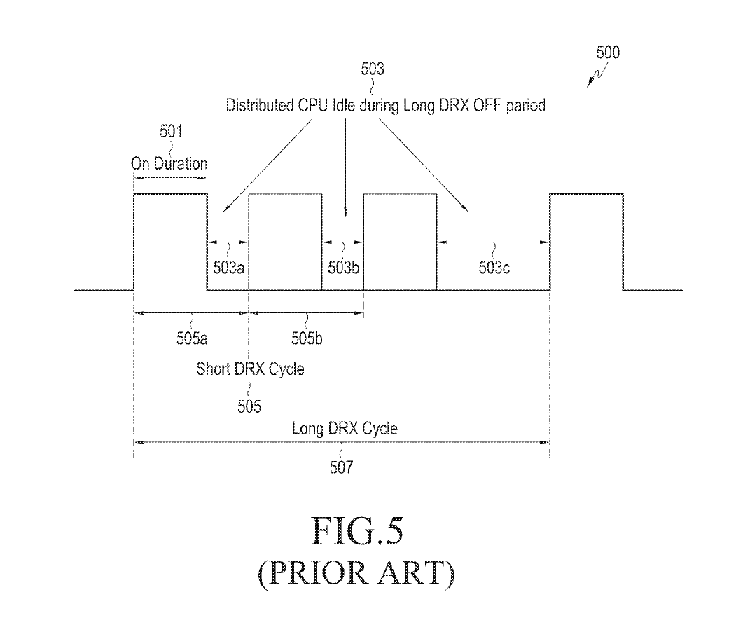

FIG. 5 is a timing graph 500 illustrating existing distributed CPU idle time due to short DRX in long DRX cycles.

Referring to FIG. 5, as shown in graph 500, configuration of short DRX cycles is an optional feature, during which short DRX cycles 505 (including cycles 505a and 505b) can be implemented during OFF periods 503 (including cycles 503a, 503b, and 503c) of a long DRX cycle 507. The OFF periods 503 of the long DRX cycle identify the actual CPU idle periods. But as multiple short DRX cycles 505 are implemented during the long DRX cycle 507, the short DRX cycles 505 can reduce the CPU idle period, and thereby affecting the CPU idle period of the system.

Therefore, there is a need for an effective method and system for machine learning prediction of CPU Idle patterns for power saving in a modem SoC.

The various embodiments herein disclose a method and system for providing power management in a computing system by predicting a CPU idle pattern for power saving in a modem SOC.

The specification may refer to “an”, “one” or “some” embodiment(s) in several locations. This does not necessarily imply that each such reference is to the same embodiment(s), or that the corresponding feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. Terms, such as those defined in commonly used dictionaries, have a meaning that is consistent with their meaning in the context of the relevant art, unless expressly so defined herein.

With an objective of achieving improved power saving in a modem SoC during a CPU idle period, the present disclosure describes prediction of a CPU idle pattern and applying selective sleep during the CPU idle period.

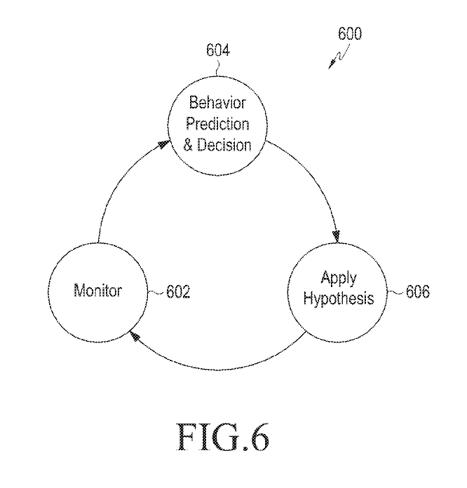

FIG. 6 is a schematic diagram illustrating a model of a machine learning process to predict CPU idle time, according to an embodiment of the present disclosure.

According to the FIG. 6, a model of a process according to an embodiment of the present disclosure includes three steps:

(a) monitoring CPU idle during run-time to understand a behavioral pattern of the CPU idle time, in step 602;

(b) predicting and deciding behavioral pattern of the CPU idle period, in step 604; and

(c) applying the predicted results to the system in such a way that selective sleep shall be enabled during that time, in step 606, thereby increasing power saving efficiency of the system.

At step 602, the CPU idle period is monitored during a run-time of the system in order to understand the behavioral pattern of the CPU idle period, during which execution of processes and entrance of the CPU into the idle period is observed. Along with observing process execution, the duration of CPU idle period after performance of a specific type of process is also observed, which can identify and can used to infer that the CPU can enter into idle state for a particular period of time after executing the specific type of process. For example, the CPU can take n1 seconds to execute a process A and can be in idle state for m1 seconds after executing the process A. Similarly for executing the process B, the CPU can take n2 seconds for execution and can be in idle state for m2 seconds after executing the process B. After observing the execution pattern, the system assumes that whenever process A or another process similar to the process A is executed, the CPU idle period after execution of the process will be m1 seconds.

According to an embodiment of the present disclosure, the monitoring of the CPU idle period of the system can be performed in terms of a fixed span of time. According to another embodiment of the present disclosure, the monitoring of the CPU idle period of the system can be based on a frame sync rate.

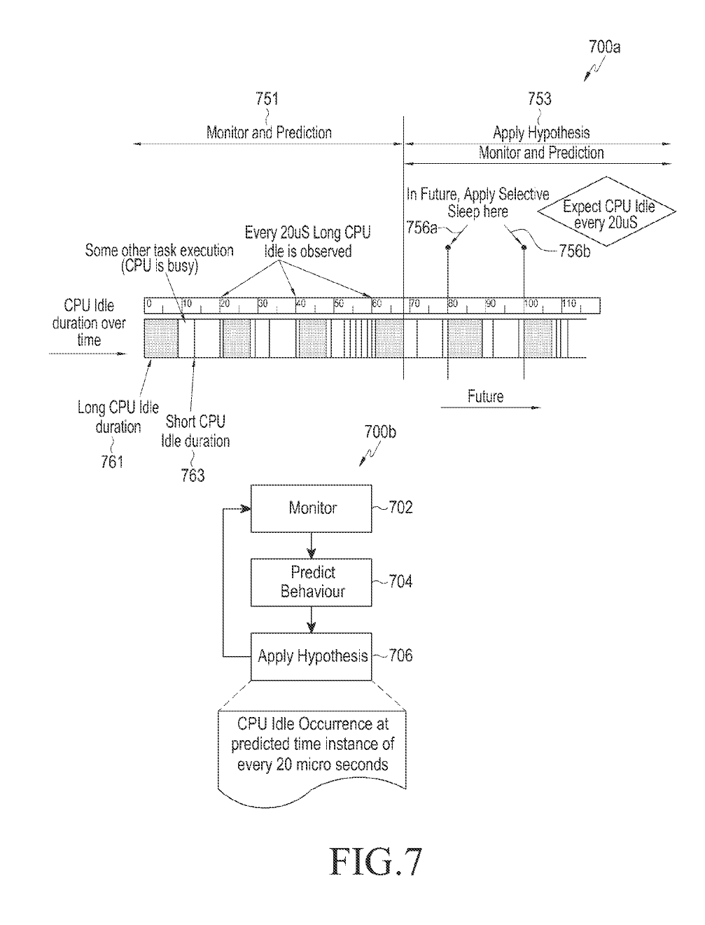

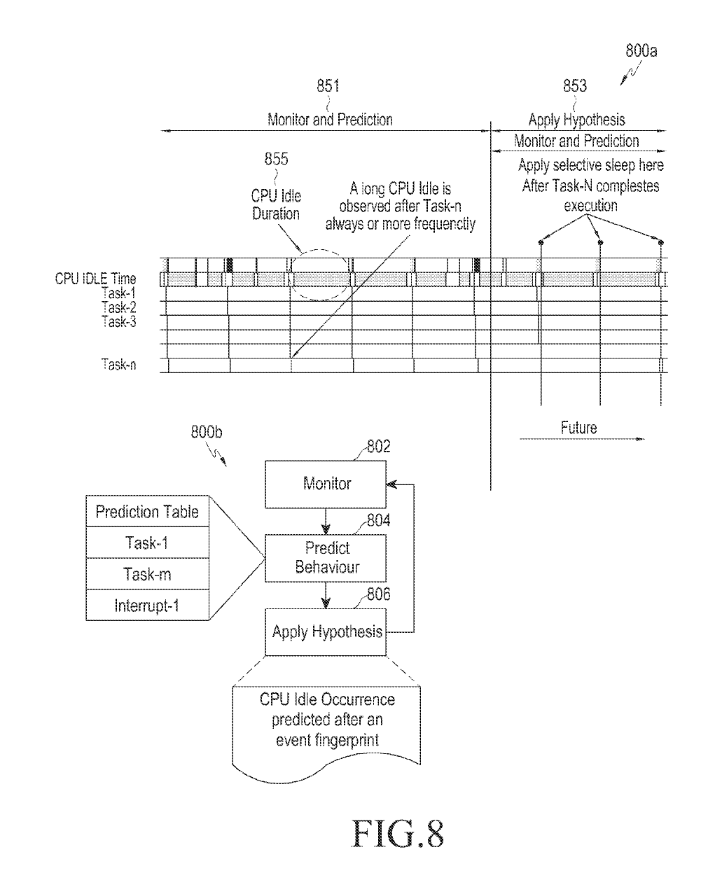

At step 604, a CPU behavioral pattern is identified, and a CPU idle pattern for a particular scenario, which indicates how the CPU behaves during and after execution of particular type of process, is determined. The behavioral pattern of the CPU can be recorded and the decision to apply selective sleep mode can be performed based on the records. The decision to apply selective sleep mode can be taken in two different ways: (1) prediction over time and (2) prediction over an event fingerprint, which are described herein with reference to FIGS. 7 and 8, respectively.

At step 606, based on the obtained decision, the calculated results are applied to the system. The obtained results indicate which CPU idle time period is suitable for applying a selective sleep mode to the system, such that power saving efficiency of the system increases. According to the obtained decision, selective sleep mode is applied to the system only during the particular CPU idle time period, and selected peripherals and sub systems are sent into sleep mode. Other peripherals and sub systems can be in active mode while the CPU is in idle state. Different peripherals and sub systems can be in sleep mode based on the CPU idle period, behavioral pattern observed, process under execution, etc., but embodiments of the present disclosure are not limited thereto. As the selected peripherals and sub systems are in sleep mode during CPU idle period, power consumption of the system is reduced, thereby increasing the power saving efficiency.

FIG. 7 is a schematic diagram illustrating a method of making decisions over time based on behavior prediction, according to an embodiment of the present disclosure.

Referring to method 700b of FIG. 7, according to the present method, at step 702, each instance of a CPU idle period can be monitored during a run-time of a system. The CPU idle period can be monitored for a number ‘n’ instances to identify different scenarios of the CPU idle period. At step 704, based on the obtained different CPU idle period scenarios during monitoring, a start of CPU idle time longer than a defined threshold can be predicted. At step 706, the calculated hypothesis (i.e., prediction) can be applied by marking future timestamps, which correspond to future CPU idle times predicted to be longer than the threshold, in a timer frame as selected positions where a power saving process can be triggered, if the system is in a CPU idle state.

In FIG. 7, graph 700a illustrates an example in which a portion of a time frame is considered for execution of a process by the CPU. During a first 751, every 20 micro seconds, a long CPU idle period is monitored to determine the maximum available long CPU idle period during which the CPU enters into idle period. In graph 700a, if the CPU is occupied with a process, then the duration for which the CPU is busy is shaded, such as shown at shaded period 761 and the duration for which the CPU is idle is left unshaded. If the CPU is busy for a small period of time, this busy time can also be observed and reported, such as shown at shaded period 763.

In a manner similar to performing monitoring for a long CPU idle state every 20 micro seconds, a long CPU idle can be monitored every 40 micro seconds or 60 micro seconds. Based on the observations obtained every 20 micro seconds, during a second period 753, a long CPU idle period can be predicted and the idle time period for applying a selective sleep mode for selected peripherals and sub systems can be calculated. Once the long CPU idle period is predicted, the selective sleep mode can be applied during every upcoming 20 micro second time period, such as at time points 756a and 756b. Even during applying selective sleep mode to each upcoming 20 micro second time period, monitoring and predicting of the long CPU idle can be performed, as the behavior and CPU idle pattern can vary based on different circumstances, such as an incoming process execution request by a user, or receipt of any other emergency process for execution.

FIG. 8 is a schematic diagram illustrating an event fingerprint method for making decisions over time based on behavior prediction, according to an embodiment of the present disclosure. Referring to method 800b of FIG. 8, at step 802, each instance of a CPU idle period can be monitored during a run-time of a system for different tasks. The CPU idle period can be monitored for a number ‘n’ instances of n different tasks to identify different scenarios of the CPU idle period. At step 804, based on the obtained different CPU idle period scenarios during monitoring, prediction of the interrupt or task that is executed before a CPU idle pattern and longer than a threshold is performed. At step 806, the calculated hypothesis can be applied by marking these predicted future interrupts or tasks in prediction table, so that in future whenever system enters CPU idle state after such a task or interrupt occurs, a power saving process can be triggered.

In FIG. 8 graph 800a illustrates an example in which a portion of a time frame is considered the execution of task-1, task-2, task-3, . . . task-n by the CPU. During a first period 851, a long CPU idle period, such as period 855, can monitored to determine the maximum available long CPU idle period during which the CPU enters into idle period for tasks 1, 2, 3, . . . n. Based on the above monitoring, a prediction of which interrupt or task is to be executed before CPU idle pattern is performed, and interrupts or tasks that will be executed longer than the threshold are observed.

These interrupts or tasks can be marked in the prediction table. During a second period 853, the calculated and observed pattern can be applied to the tasks after certain interval, such that, in the future, whenever the system enters a CPU idle state after the marked task or interrupt, a power saving selective sleep mode can be triggered. The marked interrupt or task can be a single event or an event fingerprint where a sequential execution of particular events resulted in a longer CPU idle state. Even during application of the selective sleep mode to the marked interrupts or tasks during the CPU idle state, monitoring and predicting the long CPU idle can also be performed, as the behavior and CPU idle pattern can vary based on different circumstances, such as an incoming process execution request by a user, or receipt of any other emergency process for execution.

According to the present disclosure, prediction of a CPU idle state may fail for certain scenarios where the execution process changes rapidly in time and the frequency of repetitive execution patterns are diminished. These scenarios may be occasional and exist for a limited time. During this phenomenon, prediction might be incorrect resulting in triggering selective sleep even for a short CPU idle state. As discussed earlier, enabling selective sleep during a short CPU idle state may consume a little more power than usual. The additional power consumption caused by such prediction failures can be overcome by updating the prediction table based on current execution patterns.

The present disclosure uses a negative feedback mechanism for the prediction process, and any change in the system execution pattern observed by the monitor task will automatically update prediction table, which, in turn, corrects the hypothesis. Therefore, the prediction table update is self-regulated and recovers from any prediction failures.

Although certain examples have been used in the above-described embodiments; it will be evident that various modifications and changes may be made to these embodiments without departing from the broader spirit and scope thereof. Further, the various devices, modules, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

While the present disclosure includes reference to certain embodiments thereof, it will be understood by those of ordinary skill in the art that various changes in form and details may be made therein without departing from the spirit and scope of the present disclosure as defined by the following claims and their equivalents.

What is claimed is:

1. A method of providing power management in a system employing a Central Processing Unit (CPU) and an operating system, the method comprising:
monitoring idle times of the CPU;
predicting an idle pattern based on the monitored idle times; and
determining a selective sleep of a peripheral device based on the predicted CPU idle pattern.

2. The method of claim 1, wherein the monitored idle times are idle times of a task whose monitored idle times are longer than a pre-defined threshold adapted for triggering power saving.

3. The method of claim 1, wherein the monitored idle time is monitored based on at least one of a fixed span time and a frame synchronization rate.

4. The method of claim 3, wherein predicting the idle pattern based on the fixed time span comprises:
predicting, for a selected time frame, the idle time that is longer than the pre-defined threshold; and
marking, in the selected time frame, a time stamp corresponding to the idle time as a position for triggering power saving when the computing system is in idle mode.

5. The method of claim 3, wherein predicting the idle pattern based on the frame synchronization rate comprises:
identifying one of a task and an interrupt that is executed before the idle pattern;
verifying whether the idle pattern corresponding to the execution of the identified one of the task and the interrupt is longer than the pre-defined threshold; and
marking the identified one of the task and the interrupt in a prediction table for triggering power saving for a next CPU idle state.

6. The method of claim 5, wherein the task comprises at least one of:
a single event; or
an event fingerprint of selected events, where a sequential execution of the selected events resulted in an increased idle time of the CPU.

7. The method of claim 6, wherein the prediction table is updated in response to a change in an execution pattern of the single event or the selected fingerprint.

8. The method of claim 1, wherein determining the selective sleep comprises:
turning off a peripheral device that is non-functional during the monitored idle times.

9. An apparatus for performing power management in a system employing a Central Processing Unit (CPU) and an operating system, the apparatus comprising:
a monitoring unit adapted for monitoring idle times of the CPU;
a predictor adapted for predicting an idle pattern of the CPU based on the monitored idle times; and
a controller adapted for determining a selective sleep of a peripheral device based on the predicted idle pattern.

10. The apparatus of claim 9, wherein the monitored idle times are idle times of a task whose monitored idle times are longer than a pre-defined threshold adapted for triggering power saving.

11. The apparatus of claim 9, wherein the monitoring unit monitors the idle times based on at least one of a fixed span time and a frame synchronization rate.

12. The apparatus of claim 11, wherein if the predictor predicts the idle pattern based on the fixed time span, the predictor predicts, for a selected time frame, the idle time that is longer than the pre-defined threshold, and mars, in the selected time frame, a time stamp corresponding to the idle time as a position for triggering power saving when the computing system is in idle mode.

13. The apparatus of claim 11, wherein if the predictor predicts the idle pattern based on the frame synchronization rate, the predictor identifies one of a task and an interrupt that is executed before the idle pattern, verifies whether the idle pattern corresponding to the execution of the identified one of the task and the interrupt is longer than the pre-defined threshold, and marks the identified one of the task and the interrupt in a prediction table for triggering power saving for a next idle state.

14. The apparatus of claim 13, wherein the task comprises at least one of:
a single event; and
an event fingerprint of selected events, where a sequential execution of the selected events resulted in an increased idle time of the CPU.

15. The apparatus of claim 14, wherein the prediction table is updated in response to a change in an execution pattern of the single event or the selected fingerprint.

16. The apparatus of claim 9, wherein the controller turns off a selected peripheral device that is non-functional during the monitored CPU idle times.
